(19) United States
(12) Patent Application Publication
(10) Pub. No.: US 2005/0147248 A1
(43) Pub. Date: Jul. 7, 2005

(54) Window shaping functions for watermarking of multimedia signals

(75) Inventors: Aweke Negash Lemma, Eindhoven (NL); Javier Francisco Aprea, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/509,414

(22) PCT Filed: Feb. 26, 2003
(86) PCT No.: PCT/IB03/00800

(30) Foreign Application Priority Data
Mar. 28, 2002 (EP) 02076204.3

(51) Int. Cl. H04N 7/167

(52) U.S. Cl. 380/203

(57) ABSTRACT

A window shaping function is described which has an integral over the window shaping function of zero. Compared with conventional window shaping functions, this window shaping function improves the robustness of the watermark signal for a given quality of host signal. Methods and apparatus suitable for utilizing this window shaping function within a watermarking scheme are described.

The present invention relates to window shaping functions, and the use of such functions in apparatus and methods for encoding and decoding information in multimedia signals, such as audio, video or data signals.

Watermarking of multimedia signals is a technique for the transmission of additional data along with the multimedia signal. For instance, watermarking techniques can be used to embed copyright and copy control information into audio signals.

The main requirement of a watermarking scheme is that it is not observable (i.e. in the case of an audio signal, it is inaudible) whilst being robust to attacks to remove the watermark from the signal (e.g. removing the watermark will damage the signal). It will be appreciated that the robustness of a watermark will normally be a trade off against the quality of the signal in which the watermark is embedded. For instance, if a watermark is strongly embedded into an audio signal (and is thus difficult to remove) then it is likely that the quality of the audio signal will be reduced.

Various types of audio watermarking schemes have been proposed, each with its own advantages and disadvantages. For instance, one type of audio watermarking scheme is to use temporal correlation techniques to embed the desired data (e.g. copyright information) into the audio signal. This technique is effectively an echo-hiding algorithm, in which the strength of echo is determined by solving a quadratic equation. The quadratic equation is generated by auto-correlation values at two positions: one at delay equal to r, and one at delay equal to 0. At the detector, the watermark is extracted by determining the ratio of the auto correlation function at the two delay positions.

WO 00/00969 describes an alternative technique for embedding or encoding auxiliary signals (such as copyright information) into a multimedia host or cover signal. A replica of the cover signal, or a portion of the cover signal in a particular domain (time, frequency or space), is generated according to a stego key, which specifies modification values to the parameters of the cover signal. The replica signal is then modified by an auxiliary signal corresponding to the information to be embedded, and inserted back into the cover signal so as to form the stego signal.

At the decoder, in order to extract the original auxiliary data, a replica of the stego signal is generated in the same manner as the replica of the original cover signal, and requires the use of the same stego key. The resulting replica is then correlated with the received stego signal so as to extract the auxiliary signal.

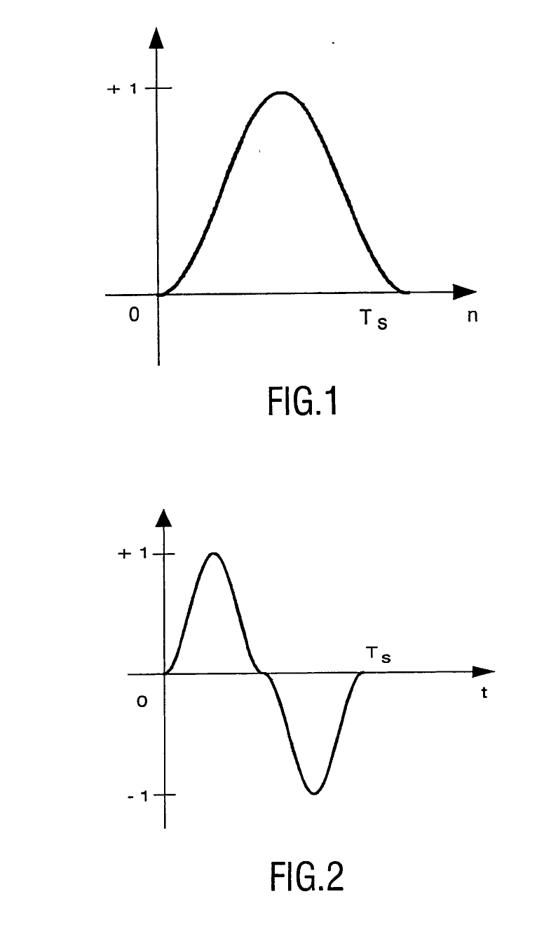

In such watermarking schemes the additional data to be embedded within the multimedia signal typically takes the form of a sequence of values. This sequence of values is then converted into a slowly varying narrow-band signal by applying a window shaping function to each value. To date, only bell shaped window shaping functions such as raised cosine functions (e.g. the Hanning window function shown in FIG. 1) have been utilized.

It is an object of the present invention to provide an alternative window shaping function that allows improved performance over prior art window shaping functions.

In a first aspect, the present invention provides a method of generating a watermark signal for embedding in a multimedia host signal, the method comprising the steps of: taking a first sequence of values; applying a window shaping function to said sequence of values so as to form a smoothly varying signal suitable for embedding in the host signal; wherein the integral over the window shaping function is zero.

Preferably, said window shaping function has an anti-symmetric temporal behavior.

Preferably, said window shaping function has a bi-phase behavior.

Preferably, the bi-phase window comprises at least two Hanning windows of opposite polarities.

Preferably, the frequency spectrum of the smoothly varying signal has a DC component less than a component of any non-DC peak within the frequency spectrum.

Preferably, each value of the first sequence is represented by a pulse train of width Tₛ so as to form a rectangular wave signal, the window shaping function also being of width Tₛ.

Preferably, said first sequence of values is convolved with the window shaping function so as to form said smoothly varying signal.

Preferably, the method further comprises the step of embedding said smoothly varying signal into the host signal.

In a further aspect, the present invention provides an apparatus arranged to generate a watermark signal suitable for embedding in a host multimedia signal, the apparatus comprising:
a) a signal generator arranged to generate a watermark signal by taking a first sequence of values; and
b) processing means arranged to apply a window shaping function to said sequence of values so as to form a smoothly varying signal suitable for embedding in a host signal; wherein the integral over the window shaping function is zero.

Preferably, the apparatus further comprises a watermark embedding apparatus that embeds said smoothly varying signal into the host signal.

In another aspect, the present invention provides a multimedia signal comprising a watermark, wherein the original multimedia signal has been watermarked by a smoothly varying signal formed by applying a window shaping function to a sequence of values, the integral over the window shaping function being zero.

Preferably, the temporal envelope of the original signal has been modified by the watermark.

In a further aspect, the present invention provides a method of detecting a watermark signal embedded in a multimedia signal, the method comprising the steps of:
receiving a multimedia signal that may potentially be watermarked by a watermark signal modifying the host multimedia signal;
extracting an estimate of the watermark from said received signal by assuming that the watermark comprises a sequence of values to which a window shaping function has been applied, the integral over the window shaping function being zero; and
processing the estimate of the watermark with a referenced version of the watermark so as to determine whether the received signal is watermarked.

Preferably, the method further comprises the step of applying a window shaping function to said received signal, the integral over the window shaping function being zero.

Preferably, the watermark signal has a payload, and the method further comprises the step of determining the payload of the watermark.

In another aspect, the present invention provides a watermark detector apparatus arranged to detect whether a watermark signal is embedded within a multimedia signal, the watermark detector comprising:
a receiver arranged to receive a multimedia signal that may potentially be watermarked by a watermark signal modifying the host multimedia signal;
an extractor arranged to extract an estimate of the watermark from said received signal by assuming that the watermark comprises a sequence of values to which a window shaping function has been applied, the integral over the window shaping function being zero; and
a processor arranged to process the estimate of the watermark with a referenced version of the watermark so as to determine whether the received signal is watermarked.

Preferably, the apparatus further comprises a unit arranged to apply a window shaping function to the said received signal, wherein the integral over the window shaping function is zero.

For a better understanding of the invention, and to show how embodiments of the same may be carried into effect, reference will now be made, by way of example, to the accompanying diagrammatic drawings in which:

FIG. 1 illustrates a Hanning window shaping function, as utilized in the prior art;

FIG. 2 illustrates a bi-phase window shaping function according to a preferred embodiment of the present invention, in which the shapes of the two lobes are Hanning window functions;

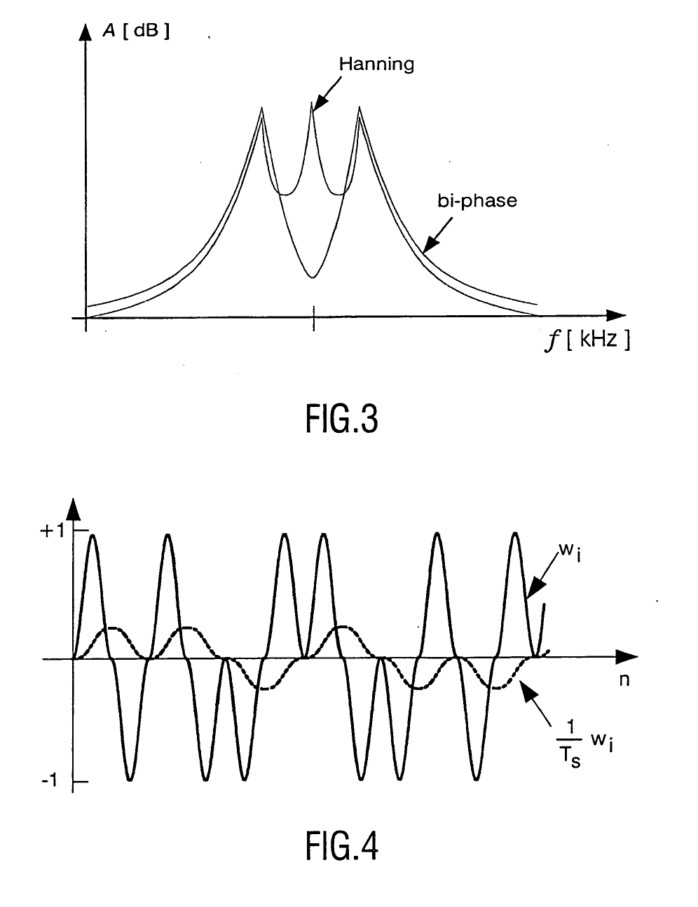

FIG. 3 illustrates frequency spectra for a sequence w_{di}[k]={1,1,−1,1,−1,−1} conditioned with respectively a Hanning window shaping function and a bi-phase window shaping function;

FIG. 4 illustrates a sequence wᵢ formed by conditioning the sequence w_{di} with the bi-phase window shaping function shown in FIG. 2, and a running integral of wᵢ (∫wᵢ);

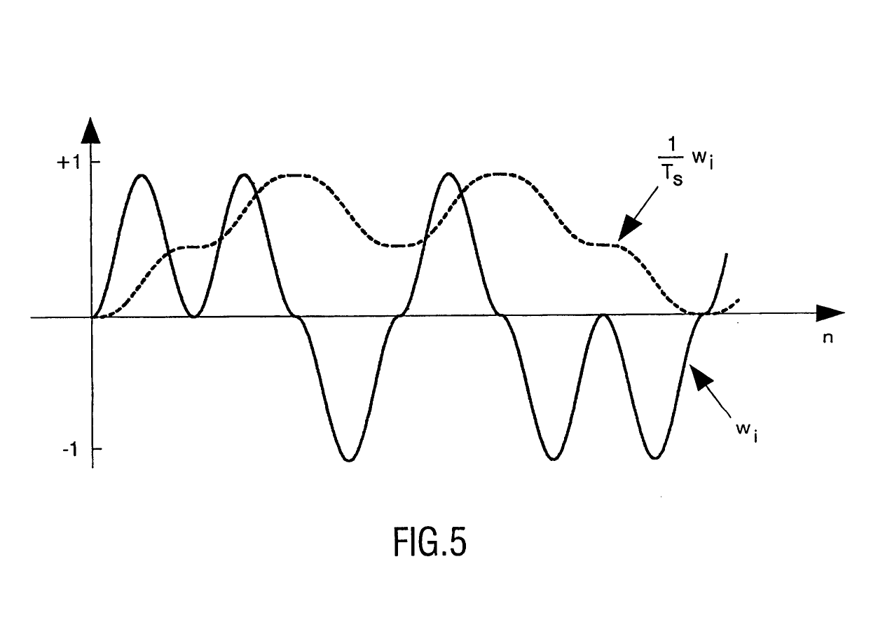

FIG. 5 illustrates a sequence wᵢ formed by conditioning the sequence w_{di} with the Hanning window shaping function, and a running integral of wᵢ (∫wᵢ);

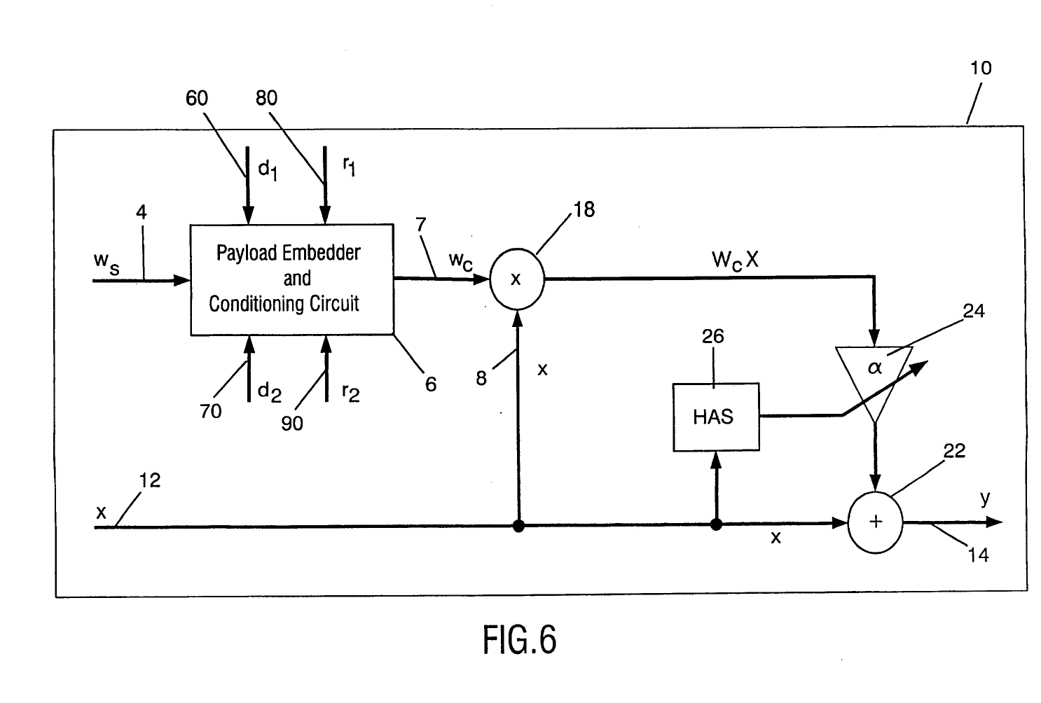

FIG. 6 is a diagram illustrating a watermark embedding apparatus in accordance with an embodiment of the present invention;

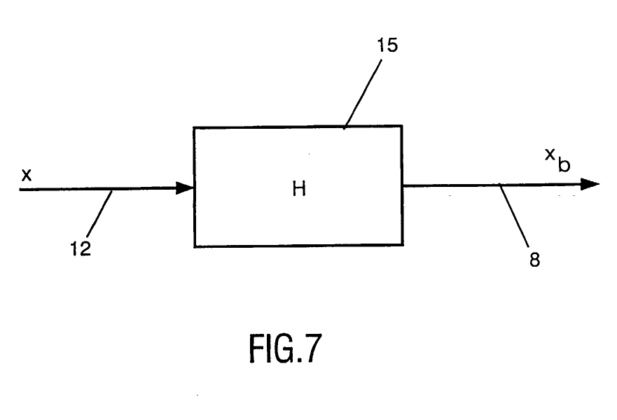

FIG. 7 shows a signal portion extraction filter H used in one preferred embodiment;

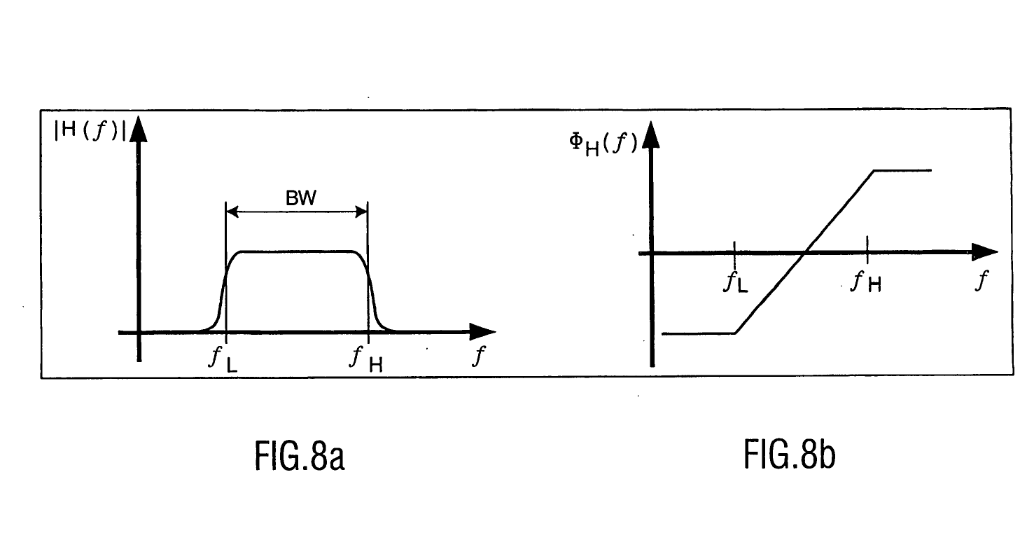

FIGS. 8a and 8b show respectively the typical amplitude and phase responses of the filter H shown in FIG. 7 as functions of frequency;

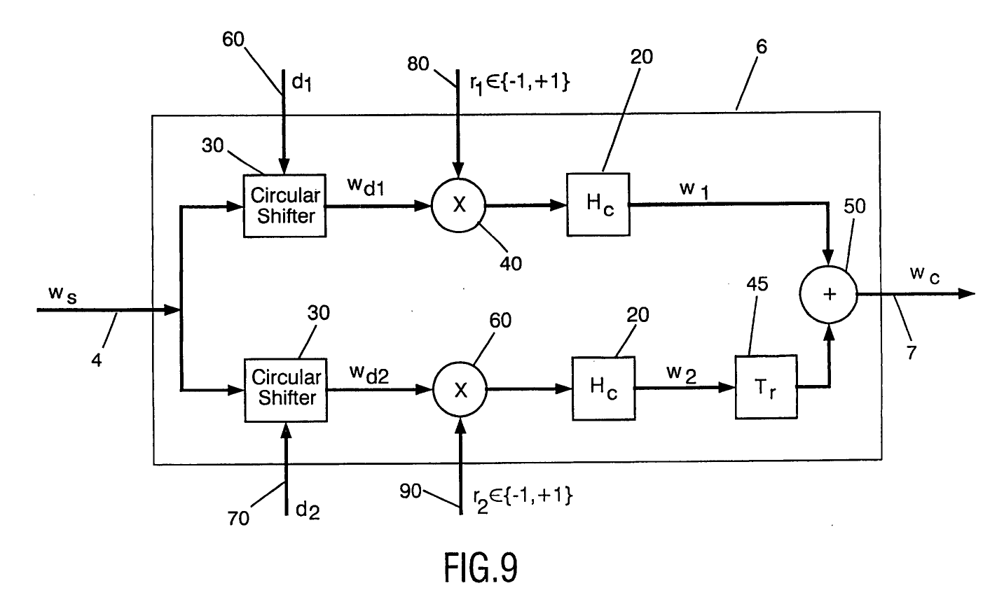

FIG. 9 shows the payload embedding and watermark conditioning stage;

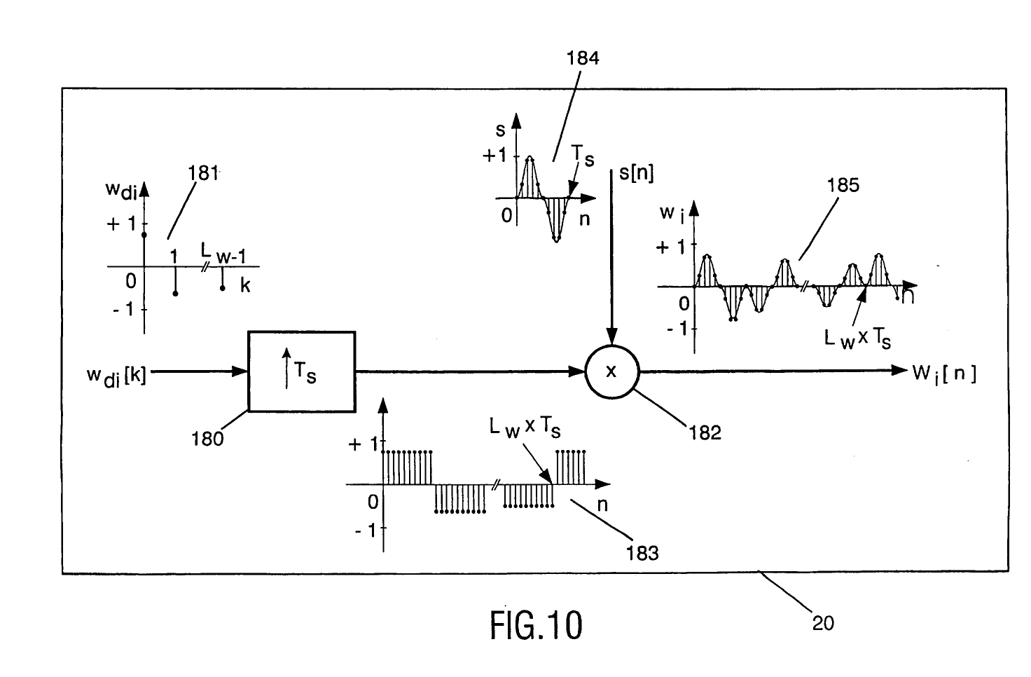

FIG. 10 is a diagram illustrating the details of one possible implementation of the watermark conditioning apparatus H_{c} of FIG. 9, including charts of the associated signals at each stage;

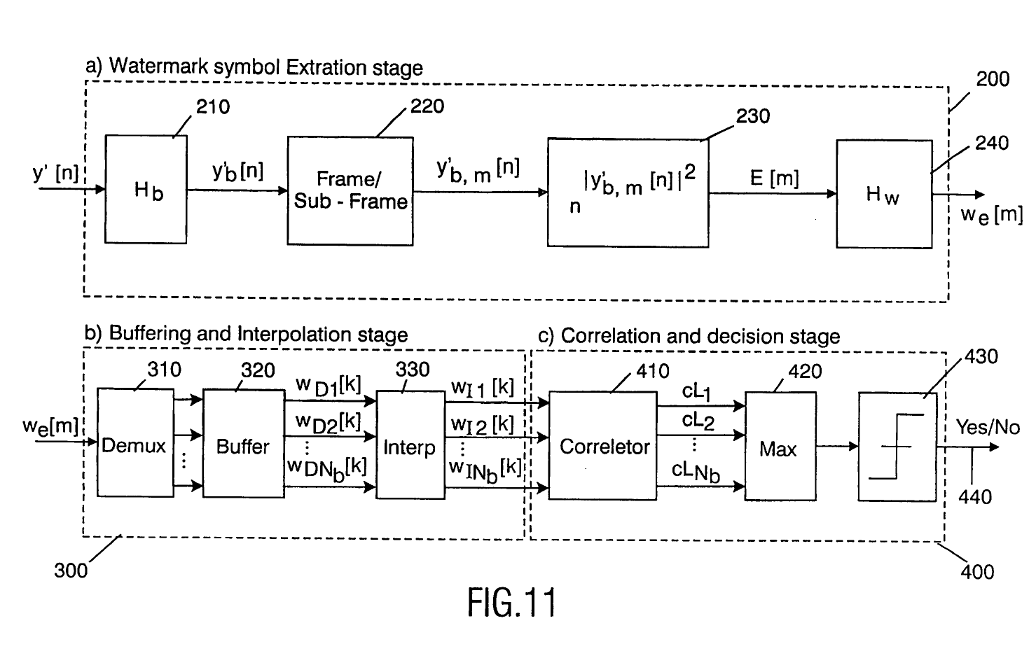

FIG. 11 is a diagram illustrating a watermark detector in accordance with an embodiment of the present invention;

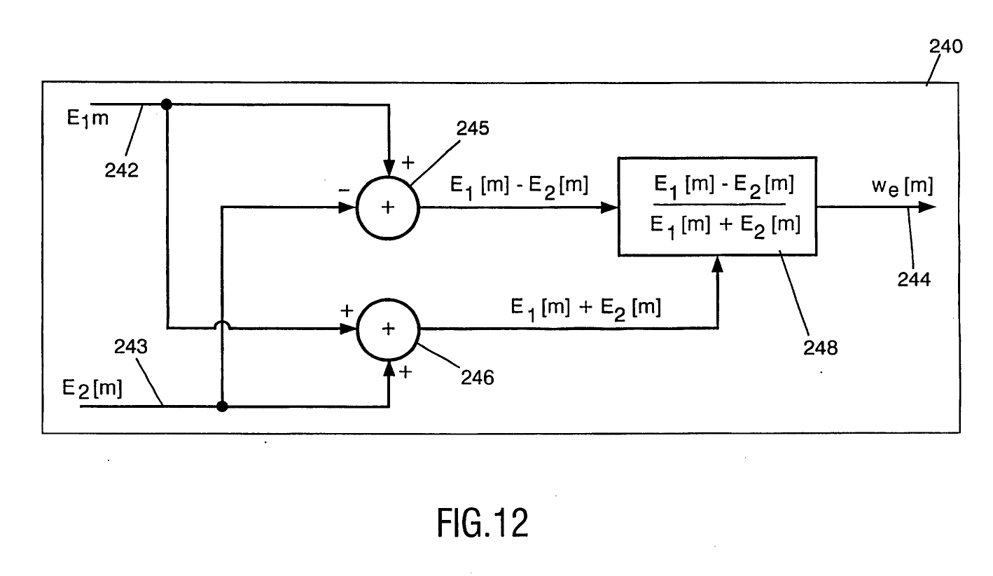

FIG. 12 diagrammatically shows the whitening filter H_{w} of FIG. 11, for use in conjunction with a bi-phase window shaping function;

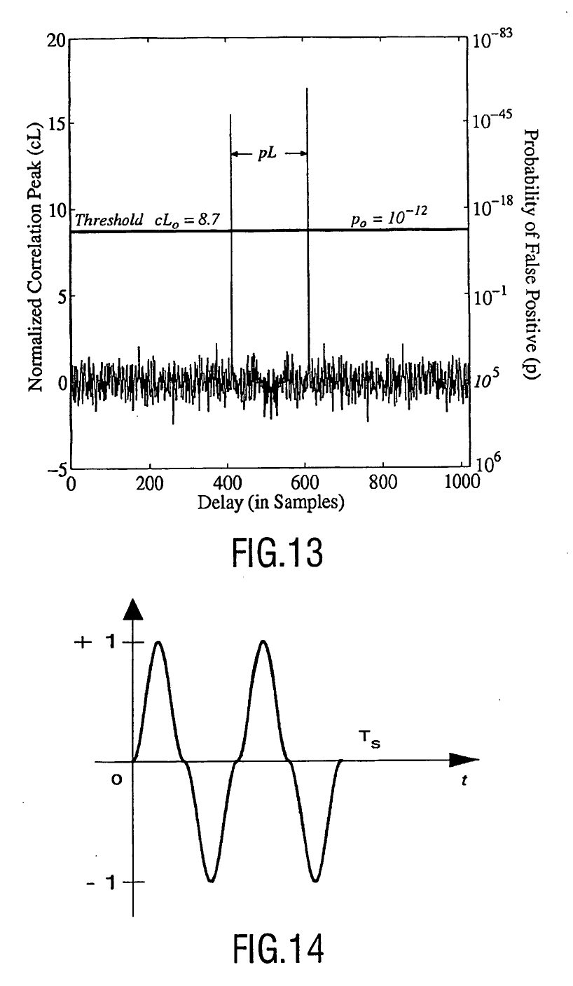

FIG. 13 shows a typical shape of the correlation function output from the correlator of the watermark detector shown in FIG. 11; and

FIG. 14 illustrates a further window shaping function according to an alternative embodiment of the present invention.

FIG. 2 shows a window shaping function as a function of time according to a preferred embodiment of the present invention. The integral over the window shaping function is zero i.e. the total positive area of the function is equal to the total-negative area (such that the average area is zero). The window shaping function is a bi-phase function with anti-symmetric temporal behavior, where each lobe of the window function is a Hanning window function.

Use of this window shaping function within watermarking schemes has been shown to offer improved performance compared with the use of the Hanning window shaping function shown in FIG. 1.

FIG. 3 illustrates the frequency spectra corresponding to a watermark sequence (w_{di}[k]={1,1,−1,1,−1,−1}) conditioned with respectively a Hanning and a bi-phase window shaping function. As can be seen, the frequency spectrum for the Hanning window conditioned watermark sequence has a maximum at frequency f=0, whilst the frequency spectrum for the bi-phase shaped watermark sequence has a minimum at f=0 i.e. it has very little DC component.

In many instances, useful information is contained in the non-DC component of the watermark only. Consequently, for the same added watermark energy, a watermark conditioned with the bi-phase window will carry more useful information than one conditioned by the Hanning window shaping function. As a result, the bi-phase window offers superior audibility performance for the same robustness, or conversely, it allows a better robustness for the same audibility quality.

FIG. 4 illustrates a normalized integral (shown as a dotted line) for the sequence w_{di} conditioned with the bi-phase window shaping function shown in FIG. 2. Conversely, FIG. 5 shows a normalized integral for the same sequence conditioned with the Hanning window shaping function. It can be seen that the maximum value of the normalized integral is lower for the sequence conditioned by the bi-phase window function as compared to that for the sequence conditioned by the Hanning window function.

Use of this window shaping function will now be described in conjunction with a watermarking scheme. However, it will of course be appreciated that the application of this window shaping function is not restricted to the below scheme, but could be applied to other watermarking techniques, particularly time domain watermarking techniques. It can also be used to carry secret keys (e.g. cryptographic keys) that can be used for the re-generation of reference random sequences at the detector side, allowing the possibility of embedding different random sequences in different host signals.

FIG. 6 shows a block diagram of the apparatus required to perform the digital signal processing for embedding a multi-bit payload watermark w_{c} into a host signal x in accordance with a preferred embodiment to the present invention.

A host signal x is provided at an input 12 of the apparatus. The host signal x is passed in the direction of output 14 via the adder 22. However, a replica of the host signal x (input 8) is split off in the direction of the multiplier 18, for carrying the watermark information.

The watermark signal w_{c} is obtained from the payload embedder and watermark conditioning apparatus 6, and is derived from the watermark random sequence wₛ, which is input to the payload embedder and watermark conditioning apparatus. The multiplier 18 is utilized to calculate the product of the watermark signal w_{c} and the replica audio signal x. The resulting product, w_{c}x is then passed via a gain controller 24 to the adder 22. The gain controller 24 is used to amplify or attenuate the signal by a gain factor α.

The gain factor α controls the trade off between the audibility and the robustness of the watermark. It may be a constant, or variable in at least one of time, frequency and space. The apparatus in FIG. 6 shows that, when a is variable, it can be automatically adapted via a signal analyzing unit 26 based upon the properties of the host signal x. Preferably, the gain α is automatically adapted, so as to minimize the impact on the signal quality, according to a properly chosen perceptibility cost-function, such as a psycho-acoustic model of the human auditory system (HAS). Such a model is, for instance, described in the paper by E. Zwicker, “Audio Engineering and Psychoacoustics: Matching signals to the final receiver, the Human Auditory System”, Journal of the Audio Engineering Society, Vol. 39, pp. Vol. 115-126, March 1991.

In the following, an audio watermark is utilized, by way of example only, to describe this embodiment of the present invention.

The resulting watermark audio signal y is then obtained at the output 14 of the embedding apparatus 10 by adding an appropriately scaled version of the product of w_{c} and x to the host signal:
y[n]=x[n]+αw[n]x[n]. (1)

Preferably, the watermark w_{c} is chosen such that when multiplied with x, it predominantly modifies the short time envelope of x.

FIG. 7 shows one preferred embodiment in which the input 8 to the multiplier 18 in FIG. 6 is obtained by filtering the replica of the host signal x using a filter H in the filtering unit 15. If the filter output is denoted by x_{b}, then according to this preferred embodiment, the watermark signal is generated by adding the product of x_{b} and the watermark w_{c} to the host signal x.

Let \overline{x}_{b} be defined such that \overline{x}_{b}=x−x_{b}, and y_{b} be defined such that y=y_{b}+\overline{x}_{b}, then the watermarked signal y can be written as
y[n]=(1+w_{c}[n])x_{b}[n]+\overline{x}_{b}[n]. (2)
and the envelope modulated portion y_{b} of the watermarked signal y is given as
y_{b}[n]=(1+w_{c}[n])x_{b}[n] (3)

Preferably, as shown in FIG. 8, the filter H is a linear phase band-pass filter characterized by its lower cut off frequency f_{L} and upper cut off frequency f_{H}. As can be seen in FIG. 8b, the filter H has a linear phase response with respect to frequency f within the pass band (BW). Thus, when H is a band-pass filter, x_{b} and \overline{x}_{b} are the in-band and out-of-band components of the host signal respectively. For optimum performance, it is preferable that the signals x_{b} and \overline{x}_{b} are in phase. This is achieved by appropriately compensating for the phase distortion produced by filter H. In the case of a linear phase filter, the phase distortion is a simple delay.

In FIG. 9, the details of the payload embedder and watermark conditioning unit 6 is shown. In this unit the watermark seed signal wₛ is converted into a multi-bit watermark signal w_{c}.

Firstly a finite length, preferably zero mean and uniformly distributed random sequence wₛ is generated using a random number generator with an initial seed S. As will be appreciated later, it is preferable that this initial seed S is known to both the embedder and the detector, such that a copy of the watermark signal can be generated at the detector for comparison purposes. This results in the sequence of length L_{w}
wₛ[k]ε[−1,1], for k=0,1,2, . . . ,L_{w}−1 (4)

Then the sequence w_{S} is circularly shifted by the amounts d₁ and d₂ using the circularly shifting units 30 to obtain the random sequences w_{d1} and w_{d2} respectively. It will be appreciated that these two sequences (w_{d1} and w_{d2}) are effectively a first sequence and a second sequence, with the second sequence being circularly shifted with respect to the first. Each sequence w_{di}, i=1,2, is subsequently multiplied with a respective sign bit rᵢ, in the multiplying unit 40, where rᵢ=+1 or −1, the respective values of r₁ and r₂ remaining constant, and only changing when the payload of the watermark is changed. Each sequence is then converted into a slowly varying narrow-band signal wᵢ of length L_{w}Tₛ by the watermark conditioning circuit 20 shown in FIG. 9. Finally, the slowly varying narrow-band signals w, and w₂ are added with a relative delay Tᵣ (where Tᵣ<Tₛ) to give the multi-bit payload watermark signal w_{c}. This is achieved by first delaying the signal w₂ by the amount Tᵣ using delaying unit 45 and subsequently by adding it to w₁ with the adding unit 50.

FIG. 10 shows one possible implementation of the watermark conditioning apparatus 20 used in the payload embedder and watermark conditioning apparatus 6 in more detail. The watermark random sequence wₛ is input to the conditioning apparatus 20.

For convenience, the modification of only one of the sequences w_{di} is shown in FIG. 10, but it will be appreciated that each of the sequences is modified in a similar manner, with the results being added to obtain the watermark signal w_{c}.

As shown in FIG. 10, each watermark signal sequence w_{di}[k], i=1,2 is applied to the input of a sample repeater 180. Chart 181 illustrates one of the possible sequences w_{di} as a sequence of values of random numbers between +1 and −1, with the sequence being of length L_{w}. The sample repeater repeats each value within the watermark random sequence Tₛ times, so as to generate a pulse train signal of rectangular shape. T, is referred to as the watermark symbol period and represents the span of the watermark symbol in the audio signal. Chart 183 shows the results of the signal illustrated in chart 181 once it has passed through the sample repeater 180.

The window shaping function s[n], which is a bi-phase function as shown in FIG. 2, is then applied to convert the rectangular pulse signals derived from w_{d1} and w_{d2} into slowly varying signals w₁[n] and w₂[n] respectively. The window shaping function is of width Tₛ.

The generated signals w₁[n] and w₂[n] are then added up with a relative delay Tᵣ (where Tᵣ<Tₛ), to give the multi-bit payload watermark signal w_{c}[n] i.e.
w_{c}[n]=wᵢ[n]+w₂[n−Tᵣ] (5)

The value of Tᵣ is chosen such that the zero crossings of w₁ match the maximum amplitude points of w₂ and vice-versa. Thus, for this bi-phase window shaping function Tᵣ=Tₛ/4. For other window shaping functions, other values of Tᵣ are possible.

As will be appreciated by the below description, during detection the correlation of w_{c}[n] will generate two correlation peaks that are separated by pL (as can be seen in FIG. 13). The value pL is part of the payload, and is defined as

$$pL = \vert {d}_{2} - {d}_{1} \vert mod ( ⌈ {L}_{w} / 2 ⌉ ) \qquad ( 6 )$$

In addition to pL, extra information can be encoded by changing the relative signs of the embedded watermarks. In the detector, this is seen as a relative sign r_{sign} between the correlation peaks. It will be seen that r_{sign} can take four possible values, and may be defined as:

$${r}_{sign} = \frac{2 \cdot {ρ}_{1} + {ρ}_{2} + 3}{2} ∈ \{ 0 , 1 , 2 , 3 \} \qquad ( 7 )$$

where ρ₁=sign(cL₁) and ρ₂=sign(cL₂) are respectively estimates of the sign bits r₁ (input 80) and r₂ (input 90) of FIG. 9, and cL, and cL₂ are the values of the correlation peak corresponding to w_{d1} and w_{d2} respectively. The overall watermark payload pL_{w}, for an error free detection, is then given as a combination of r_{sign} and pL:
pL_{w}=<r_{sign}, pL>. (8)

The maximum information (Iₘₐₓ), in number of bits, that can be carried by a watermark sequence of length L_{w} is thus given by:

$${I}_{max} = {log}_{2} ( 4 \cdot ⌈ {L}_{w} / 2 ⌉ ) bits \qquad ( 9 )$$

FIG. 11 shows a block diagram of a watermark detector (200, 300, 400). The detector consists of three major stages: (a) the watermark symbol extraction stage (200), (b) the buffering and interpolation stage (300), and (c) the correlation and decision stage (400).

In the symbol extraction stage (200), the received watermarked signal y′[n] is processed to generate multiple (N_{b}) estimates of the watermarked sequence. These estimates of the watermark sequence are required to resolve a time offset that may exist between the embedder and the detector, so that the watermark detector can synchronize to the watermark sequence inserted in the host signal.

In the buffering and interpolation stage (300), these estimates are de-multiplexed into N_{b} separate buffers, and an interpolation is applied to each buffer to resolve possible timescale modifications that may have occurred e.g. a drift in sampling (clock) frequency may have resulted in a stretch or shrink in the time domain signal (i.e. the watermark may have been stretched or shrunk).

In the correlation and decision stage (400), the content of each buffer is correlated with the reference watermark and the maximum correlation peaks are compared against a threshold to determine the likelihood of whether the watermark is indeed embedded within the received signal y′[n].

In order to maximize the accuracy of the watermark detection, the watermark detection process is typically carried out over a length of received signal y′[n] that is 3 to 4 times that of the watermark sequence length. Thus each watermark symbol to be detected can be constructed by taking the average of several estimates of said symbol. This averaging process is referred to as smoothing, and the number of times the averaging is done is referred to as the smoothing factor s_{f}. Thus the detection window length L_{D} is the length of the audio segment (in number of samples) over which a watermark detection truth-value is reported. Consequently, L_{D}=s_{f}L_{w}Tₛ, where Tₛ is the symbol period and L_{w} the number of symbols within the watermark sequence. Typically, the length (L_{b}) of each buffer 320 within the buffering and interpolation stage is L_{b}=s_{f}L_{w}.

In the watermark symbol extraction stage 200 shown in FIG. 11, the incoming watermark signal y′[n] is input to the signal conditioning filter H_{b}(210). This filter 210 is typically a band pass filter and has the same behavior as the corresponding filter (H_{c}, 20) in the watermark embedder 10. The output of the filter H_{b} is y′_{b} [n], and assuming linearity within the transmission medium, it follows from equations (1) and (3):
y′_{b}[n]≈i y_{b[}n]=(1+αw[n])x_{b}[n] (10)

Note that in the above expression, the possible time offset between the embedder and the detector is implicitly ignored. For ease of explanation of the general watermarking scheme principles, from now on, it is assumed that there is perfect synchronism between the embedder and the detector (i.e. no offset). It should be noted however that if there is not perfect synchronism between the embedder and the detector, then the deviation can be compensated for within the buffering and interpolation stage 300 utilizing techniques known to the skilled person e.g. iteratively searching through alternative shifts in scale and offset until a best match is achieved.

Note that when no filter is used in the embedder (i.e., when H=1) then H_{b} in the detector can also be omitted, or it can still be included to improve the detection performance. If H_{b} is omitted, then y_{b} in equation (10) is replaced with y. The rest of the processing is the same.

Assuming that the audio signal is divided into frames of length Tₛ, and that y′_{b, m}[n] is the n-th sample of the m-th filtered frame signal, the energy E[m] corresponding to the m-th frame is thus:

$$E [ m ] = {\sum }_{n = 0}^{{T}_{s} - 1} {\vert {y}_{b , m}^{′} [ n ] S [ n ] \vert}^{2} \qquad ( 11 )$$

where S[n] is the same window shaping function used in the watermark conditioning circuit of FIG. 10. A person skilled in the art will appreciate that equation 11 represents a matched filter receiver, and is the optimum receiver when the symbol period is perfectly synchronized. Not withstanding this fact, from now on, we set S[n]=1 in order to simplify subsequent explanations.

Combining this with equation 10, it follows that:

$$E [ m ] \approx {\sum }_{n = 0}^{{T}_{s} - 1} {\vert {y}_{b , m} [ n ] \vert}^{2} = {\sum }_{n = 0}^{{T}_{s} - 1} {\vert ( 1 + α {w}_{e} [ m ] ) {x}_{b , m} [ n ] \vert}^{2} \qquad ( 12 )$$

where wₑ[m] is the m-th extracted watermark symbol and contains N_{b} time-multiplexed estimates of the embedded watermark sequences. Solving for wₑ[m] in equation 12 and ignoring higher order terms of α, gives the following approximation:

$${w}_{e} [ m ] \approx \frac{1}{2 α} ( \frac{{\sum }_{n = 0}^{{T}_{s} - 1} {\vert {y}_{b , m} [ n ] \vert}^{2}}{{\sum }_{n = 0}^{{T}_{s} - 1} {\vert {x}_{b , m} [ n ] \vert}^{2}} - 1 ) \qquad ( 13 )$$

In the watermark extraction stage 200 shown in FIG. 11, the output y′_{b}[n] of the filter H_{b} is provided as an input to a frame divider 220, which divides the audio signal into frames of length Tₛ i.e. into y′_{b,m}[n], with the energy calculating unit 230 then being used to calculate the energy corresponding to each of the framed signals as per equation (11). The output of this energy calculation unit 230 is then provided as an input to the whitening stage H_{w} (240) which performs the function shown in equation 13 so as to provide an output wₑ[m].

It will be realized that the denominator of equation 13 contains a term that requires knowledge of the host signal x. As the signal x is not available to the detector, it means that in order to calculate wₑ[m] then the denominator of equation 13 must be estimated.

Below is described how such an estimation can be achieved for the bi-phase window shaping function, but it will equally be appreciated that the teaching could be extended to other window shaping functions.

It will be seen by examination of the bi-phase window function shown in FIG. 2, that when the audio envelope is modulated with such a window function, the first and the second halves of the frame are scaled in opposite directions. In the detector, this property is utilized to estimate the envelope energy of the host signal x.

Consequently, within the detector, the audio frame is first sub-divided into two halves. The energy functions corresponding to the first and second half frames are hence given by

$${E}_{1} [ m ] = {\sum }_{n = 0}^{{T}_{s} / 2 - 1} {\vert {y}_{b , m}^{′} [ n ] \vert}^{2} \qquad ( 14 )$$

and

$${E}_{2} [ m ] = {\sum }_{n = {T}_{s} / 2}^{{T}_{s} - 1} {\vert {y}_{b , m}^{′} [ n ] \vert}^{2} \qquad ( 15 )$$

respectively. As the envelope of the original audio is modulated in opposite directions within the two sub-frames, the original audio envelope can be approximated as the mean of E₁[m] and E₂ [m].

Further, the instantaneous modulation value can be taken as the difference between these two functions. Thus, for the bi-phase window function, the watermark wₑ[m] can be approximated by:

$${w}_{e} [ m ] \approx \frac{1}{2 α} ( \frac{{E}_{1} [ m ] - {E}_{2} [ m ]}{{E}_{1} [ m ] + {E}_{2} [ m ]} - 1 ) \qquad ( 16 )$$

Consequently, the whitening filter H_{w} 240 for a bi-phase window shaping function can be realized as shown in FIG. 10. Inputs 242 and 243 respectively receive the energy functions of the first and second halve frames E₁[m] and E₂ [m]. Each energy function is then split up into two, and provided to adders 245 and 246 which respectively calculate E₁[m]−E₂ [m], and E₁[m]+E₂ [m]. Both of these calculated functions are then passed to the calculating unit 248 which divides the value from adder 245 by the value from 246 so as to calculate an estimate for the watermark wₑ[m], in accordance with equation 16.

This output we[m] is then passed to the buffering and interpolation stage 300, where the signal is de-multiplexed by the de-multiplexer 310, buffered in buffers 320 of length L_{b} so as to resolve any lack of synchronism between the embedder and the detector, and interpolated within the interpolation unit 330 so as to compensate for a possible time scale modification between the embedder and the detector. Such compensation can utilize known techniques, and hence is not described in any more detail within this specification.

As shown in FIG. 11, outputs (w_{D1}, w_{D2}, . . . W_{DNb}) from the buffering stage are passed to the interpolation stage and, after interpolation, the outputs (w_{I1}, w_{I2}, . . . w_{INb}) of this stage, which correspond to the different estimates of the correctly re-scaled signal, are passed to the correlation and decision stage. If it is believed that no time scaling compensation is required, the values (w_{D1}, w_{D2}, . . . W_{DNb}) can be passed directly to the correlation and decision stage 400 i.e. the interpolation stage 330 can be omitted from the apparatus.

The correlator 410 calculates the correlation of each estimate w_{Ij}, j=1, . . . , N_{b} with respect to the reference watermark sequence w_{c}[k]. Each respective correlation output corresponding to each estimate is then applied to the maximum detection unit 420 which determines which two estimates provided the maximum correlation peak values, and these estimates are chosen as the ones that best fit the circularly shifted versions w_{d1} and w_{d2} of the reference watermark, and the correlation values for these estimate sequences are passed to the threshold detector and payload extractor unit 430.

If the interpolation stage is omitted, alternatively the correlator 410 calculates the correlation of each estimate w_{Dj}, j=1, . . . , N_{b} with the reference watermark sequence wₛ[k] and the results are passed on for subsequent processing to the units 420 and 430 as outlined in the above paragraph.

The payload extractor unit 430 may be utilized to extract the payload (e.g. information content) from the detected watermark signal. Once the unit has estimated the two correlation peaks cL₁ and cL₂ that exceed the detection threshold, the distance pL between the peaks (as defined by equation (6)) is measured. Next, the signs ρ₁ and ρ₂ of the correlation peaks are determined, and hence r_{sign} calculated from equation (7). The overall watermark payload may then be calculated using equation (8).

For instance, it can be seen in FIG. 13 that pL is the relative distance between the two peaks. Both peaks are positive i.e. ρ₁=+1, and ρ₂=+1. From equation (7), r_{sign}=3. Consequently, the payload pL_{w}=<3, pL>.

The reference watermark sequence wₛ used within the detector corresponds to (a possibly circularly shifted version of) the original watermark sequence applied to the host signal. For instance, if the watermark signal was calculated using a random number generator with seed S within the embedder, then equally the detector can calculate the same random number sequence using the same random number generation algorithm and the same initial seed so as to determine the watermark signal. Alternatively, the watermark signal originally applied in the embedder and utilized by the detector as a reference could simply be any predetermined sequence.

FIG. 13 shows a typical shape of a correlation function as output from the correlator 410. The horizontal scale shows the correlation delay (in terms of the sequence bins). The vertical scale on the left-hand side (referred to as the confidence level cL) represents the value of the correlation peak normalized with respect to the standard deviation of the typically normally distributed correlation function.

As can be seen, the typical correlation is relatively flat with respect to cL, and centered about cL=0. However, the function contains two peaks, which are separated by pL (see equation 6) and extend upwards to cL values that are above the detection threshold when a watermark is present.

A horizontal line (shown in the Fig. as being set at cL=8.7) represents the detection threshold. The detection threshold value controls the false alarm rate.

Two kinds of false alarms exist: The false positive rate, defined as the probability of detecting a watermark in non watermarked items, and the false negative rate, which is defined as the probability of not detecting a watermark in watermarked items. Generally, the requirement of the false positive alarm is more stringent than that of the false negative. The right hand side scale on FIG. 11 illustrates the probability of a false positive alarm p. As can be seen, in the example shown, the probability of a false positive p=10⁻¹² is equivalent to the threshold cL=8.7, whilst p=10⁻⁸³ is equivalent to cL=20.

After each detection interval, the detector determines whether the original watermark is present or whether it is not present, and on this basis output a “yes” or a “no” decision. If desired, to improve this decision making process, a number of detection windows may be considered. In such an instance, the false positive probability is a combination of the individual probabilities for each detection window considered, dependent upon the desired criteria. For instance, it could be determined that if the correlation function has two peaks above a threshold of cL=7 on any two out of three detection intervals, then the watermark is deemed to be present. Obviously, such detection criteria can be altered depending upon the desired use of the watermark signal and to take into account factors such as the original quality of the host signal and how badly the signal is likely to be corrupted during normal transmission.

It will be appreciated by the skilled person that various implementations not specifically described would be understood as falling within the scope of the present invention.

For instance, whilst the implementation of a particular bi-phase window shaping function has been described, and in particular a bi-phase window shaping function in which each lobe is a Hanning function, it will be appreciated that the present invention is applicable to any window shaping function falling within the scope of the appended claims. The observed reduction in the DC component of the frequency spectrum has been determined to be related to having a window shaping function in which the integral over the function is zero i.e. the total positive area is equal to the total negative area. Use of such a function reduces the DC component of the frequency spectrum irrespective of the watermark sequence. As useful information is not carried within the DC component, but only within the non DC components of the signal, any reduction in the DC component is desirable.

FIG. 14 shows an example of an alternative window shaping function that would still fall within the scope of the present invention. The function has four lobes. The lobes between adjacent zero-crossing points are Hanning window functions. It will be appreciated that such window shaping functions can be symmetric or anti symmetric.

Whilst only the functionality of the embedding and detecting apparatus has been described, it will be appreciated that the apparatus could be realized as a digital circuit, an analog circuit, a computer program, or a combination thereof.

Equally, whilst the above embodiment has been described with reference to an audio signal, it will be appreciated that the present invention can be applied to other types of signal, for instance video and data signals.

Within the specification it will be appreciated that the word “comprising” does not exclude other elements or steps, that “a” or “and” does exclude a plurality, and that a single processor or other unit may fulfil the functions of several means recited in the claims.

1. A method of generating a watermark signal for embedding in a multimedia host signal, the method comprising the steps of: taking a first sequence of values; applying a window shaping function to said sequence of values so as to form a smoothly varying signal suitable for embedding in the host signal; wherein the integral over the window shaping function is zero.

2. A method as claimed in claim 1, wherein the window shaping function has an anti-symmetric temporal behavior.

3. A method as claimed in claim 1, wherein the window shaping function has a bi-phase behavior.

4. A method as claimed in claim 3, wherein the bi-phase window comprises at least two Hanning windows of opposite polarities.

5. A method as claimed in claim 1, wherein the frequency spectrum of the smoothly varying signal has a DC component less than a component of any non-DC peak within the frequency spectrum.

6. A method as claimed in claim 1, wherein each value of the first sequence is represented by a pulse train of width Tₛ so as to form a rectangular wave signal, the window shaping function also being of width Tₛ.

7. A method as claimed in claim 1, wherein said first sequence of values is convolved with the window shaping function so as to form said smoothly varying signal.

8. A method as claimed in claim 1, the method further comprising the step of embedding said smoothly varying signal into the host signal.

9. An apparatus arranged to generate a watermark signal suitable for embedding in a host multimedia signal, the apparatus comprising: a) a signal generator arranged to generate a watermark signal by taking a first sequence of values; and b) processing means arranged to apply a window shaping function to said sequence of values so as to form a smoothly varying signal suitable for embedding in a host signal; wherein the integral over the window shaping function is zero.

10. An apparatus as claimed in claim 9, wherein the apparatus further comprises a watermark embedding apparatus that embeds said smoothly varying signal into the host signal.

11. A multimedia signal comprising a watermark, wherein the original multimedia signal has been watermarked by a smoothly varying signal formed by applying a window shaping function to a sequence of values, the integral over the window shaping function being zero.

12. A signal as claimed in claim 11, wherein the temporal envelope of the original signal has been modified by the watermark.

13. A method of detecting a watermark signal embedded in a multimedia signal, the method comprising the steps of:
(a) receiving a multimedia signal that may potentially be watermarked by a watermark signal modifying the host multimedia signal;
(b) extracting an estimate of the watermark from said received signal by assuming that the watermark comprises a sequence of values to which a window shaping function has been applied, the integral over the window shaping function being zero; and
(c) processing the estimate of the watermark with a referenced version of the watermark so as to determine whether the received signal is watermarked.

14. A method as claimed in claim 13, the method further comprising the step of applying a window shaping function to said received signal, the integral over the window shaping function being zero.

15. A method as claimed in claim 13, wherein the watermark signal has a payload, and the method further comprises the step of determining the payload of the watermark.

16. A watermark detector apparatus arranged to detect whether a watermark signal is embedded within a multimedia signal, the watermark detector comprising:
(a) a receiver arranged to receive a multimedia signal that may potentially be watermarked by a watermark signal modifying the host multimedia signal;
(b) an extractor arranged to extract an estimate of the watermark from said received signal by assuming that the watermark comprises a sequence of values to which a window shaping function has been applied, the integral over the window shaping function being zero; and
(c) a processor arranged to process the estimate of the watermark with a referenced version of the watermark so as to determine whether the received signal is watermarked.

17. An apparatus as claimed in claim 16, wherein the apparatus further comprises a unit arranged to apply a window shaping function to the said received signal, wherein the integral over the window shaping function is zero.
